(19) United States
(12) Patent Application Publication
(10) Pub. No.: US 2020/0051150 A1
(43) Pub. Date: Feb. 13, 2020

(54) SYSTEM FOR SELECTIVELY INFORMING A PERSON

(71) Applicant: BAYER BUSINESS SERVICES GMBH, Köln (DE)

(72) Inventors: Ali KÜCÜKCAYIR, Köln (DE); Jürgen HOHMANN, Odenthal (DE)

(73) Assignee: BAYER BUSINESS SERVICES GMBH, Köln (DE)

(21) Appl. No.: 16/340,033

(22) PCT Filed: Oct. 13, 2017
(86) PCT No.: PCT/EP2017/076180

§ 371 Date: Apr. 5, 2019

(30) Foreign Application Priority Data
Oct. 20, 2016 (EP) 16194850.0

(51) Int. Cl. G06Q 30/06; G06Q 30/02; G10L 25/63; H04N 5/247; G06K 9/00

(52) U.S. Cl. CPC G06Q 30/0613; G06Q 30/0201; G06Q 30/0281; G06K 9/00892; H04N 5/247; G06K 9/00362; G06K 9/00335; G10L 25/63

(57) ABSTRACT

Systems and methods are described for selectively informing people. In some embodiments, a system includes at least three devices, each having a display screen and one or more sensors. Each device can use its one or more sensors to recognize a presence of a first person in front of that device and contactlessly determine one or more features of the first person. Example features include a sex, an association with an age group, a skin temperature, a heart rate, or a mood. Further, each device can be configured to selectively display items of information on a respective display screen opposite the first person based on registered features of the first person. In some embodiment, one of the three devices can be further configured to display items of information about the first person on another display screen opposite to a second person.

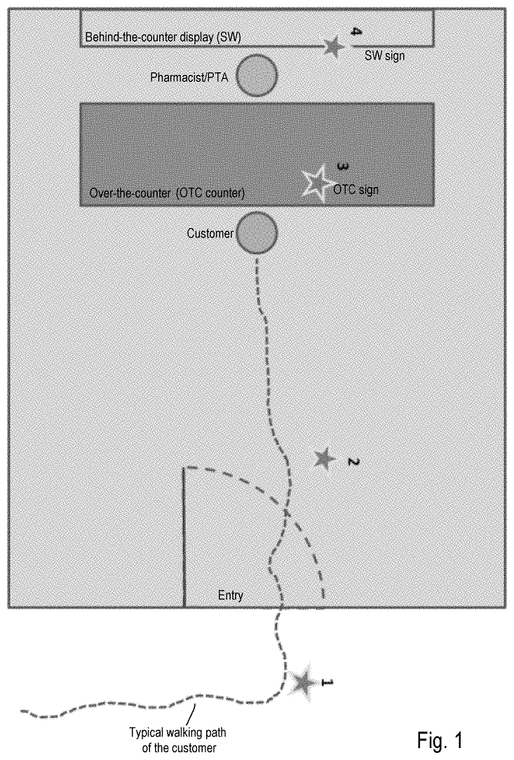

The present invention relates to a system and a method for selectively informing people.

Humans moving in current cities are confronted with a variety of instruction signs, placards, illuminated advertisements, and the like. A majority of the items of information to which a person is subjected are no longer even perceived.

On the one hand, this is because many items of information do not apply to him and/or do not interest him, on the other hand, this is because there are too many items of information which act on him.

WO2013174433A1 discloses a system for selectively informing a person. The system comprises an image registration unit, using which an image of the person is recorded and analyzed in order to determine a feature of the person. The system furthermore comprises at least two display screens, on which items of information are displayed in dependence on the registered feature. The system disclosed in WO2013174433A1 is predominantly used for advertising purposes.

US2008004950A1 discloses a similar system, using which selective advertising is to be presented. By means of a sensor component, data about a person in the vicinity of the system are obtained. The data about the person are analyzed by means of a customer component to generate a profile of the person. Finally, advertising is presented to the person in dependence on the generated profile.

The systems disclosed in the prior art have the disadvantage that the businesses which use such systems in their sales rooms rely on the customer “jumping” on the selective advertising and undertaking the next step, for example, searching out a salesperson in order to learn more about the product shown in the advertisement. Furthermore, the systems disclosed in the prior art do not have the goal of obtaining items of information about the health state of a person in order to initiate a consulting discussion on health themes.

In pharmacies and comparable businesses, in which health-promoting products are offered, it is important to consult with the customer in the best possible manner in the matter of health. The personal contact between the customer and the salesperson is particularly important here.

Proceeding from the described prior art, the technical object is to assist the salesperson in a business for health-promoting products during the consultation with a customer.

This object is achieved by the subjects of independent claims 1 and 9.

A first subject matter of the present invention is therefore a system comprising the following components:
a first device comprising a first display screen for displaying items of information and one or more sensors for recognizing the presence of a first person and for contactlessly determining the following features of the first person:
   sex
   association with an age group
a second device comprising a second display screen for displaying items of information and one or more sensors for recognizing the presence of the first person and for contactlessly determining the following features of the first person:
   sex
   association with an age group
a third device comprising a third and a fourth display screen for displaying items of information and one or more sensors for contactlessly determining the following features of the first person:
   sex
   association with an age group
   skin temperature
   heart rate
   mood
      wherein the first, the second, and the third device are configured in such a way that they display items of information on the first, second, and third display screens opposite to the first person, wherein the items of information are selected on the basis of the registered features of the first person,
      and wherein the third device is configured in such a way that it displays items of information about the first person on the fourth display screen opposite to a second person.

A further subject matter of the present invention is a method comprising the following steps:
(A1) recognizing the presence of a first person in front of a first display screen
(A2) registering the following features of the first person:
   sex
   association with an age group
(A3) displaying items of information on the first display screen in dependence on the registered features of the first person
(B1) recognizing the presence of the first person in front of a second display screen
(B2) registering the following features of the first person:
   sex
   association with an age group
(B3) displaying items of information on the second display screen in dependence on the registered features of the first person
(C1) recognizing the presence of the first person in front of a third display screen
(C2) registering the following features of the first person:
   sex
   association with an age group
   skin temperature
   heart rate
   mood
(C3) displaying items of information on the third display screen in dependence on the registered features of the first person
(D1) displaying items of information about the first person on a fourth display screen opposite to a second person.

The invention will be explained in greater detail hereafter without differentiating between the subjects of the invention (system, method). Rather, the following explanations are to apply similarly to all subjects of the invention, independently of the context (system, method) in which they occur.

For clarification, it is to be noted that it is not the goal of the present invention to register features of persons without their knowledge. In many countries of the earth, there are provisions in data protection law and personal law which are to be observed in every case. Although the registration of features of a person takes place according to the invention contactlessly and without action of the person, the consent of the person for the registration of the features has to exist. The aspects with respect to data protection law are also to be observed in the processing of personal data, of course. Finally, the present invention is to be useful to those persons from whom the physical and/or mental features are registered. The specific embodiment of the present invention is accordingly to have means which enable a person to recognize and reject or consent to a registration of physical and/or mental features.

The system according to the invention comprises at least three devices, which each have a display screen and which each have one or more sensors.

With the aid of the sensors, the presence of a person in front of the respective device is recognized and physical and/or mental features of the person are registered in order to display items of information selectively to the person in dependence on the registered features.

The devices are typically stationed at a specific location and register immediate surroundings of the devices using the sensors thereof. The use of one or more mobile devices, which can be set up as needed at one or more locations, is also conceivable. However, the devices are typically unmoving when they are used for registering features of a person in the immediate surroundings thereof.

Changes in the immediate surroundings of a device can be registered by means of sensors to recognize the presence of a person. The immediate surroundings typically relate to an angle range of 30° to 180° around the devices and a distance range of 0.1 to 10 meters.

If there is a person in these immediate surroundings, it is recognized by the respective device that it is a person.

Appropriate sensors are typically used for this purpose, for example, image sensors, distance meters, and the like. An image sensor on which the person or parts of the person are depicted is preferably used.

An image sensor is a device for recording two-dimensional images from light in an electronic manner. In most cases, semiconductor-based image sensors are used, which can record light up into the middle infrared.

Examples of image sensors in the visible range and in the near infrared are CCD sensors (CCD: charge-coupled device) and CMOS sensors (CMOS: complementary metal-oxide semiconductor).

The image sensor is connected to a computer system on which software is installed, which decides, for example, on the basis of a feature analysis of the depiction whether the imaged content is a person or not.

It is preferably determined on the basis of the presence or absence of a human face in a depiction of the surroundings of the device according to the invention registered by the image sensor whether a person is present or absent, respectively.

For this purpose, a region is preferably registered by the image sensor in which the face of a person who stops in front of the corresponding device is typically located.

Furthermore, light from the face of the person has to be incident on the image sensor. The ambient light is typically used. If the device according to the invention is located outside, thus, for example, sunlight can be used during the day. If the device according to the invention is located in a building, artificial light which illuminates the interior of the building can be used. However, it is also conceivable to use a separate light source in order to illuminate the face of the person optimally. The wavelength range in which the light source emits light is preferably adapted to the sensitivity of the image sensor used.

It can be determined with the aid of a face location method whether a face is depicted on the image sensor. If the probability that a face is depicted on the image sensor is greater than a definable threshold value (for example, 90%), it is then assumed by the computer system that a person is present. If the probability is less than the threshold value, in contrast, it is assumed by the computer system that a person is not present.

Face location methods are presently implemented in many digital cameras.

Simple face location methods search for characteristic features in the depiction, which could originate from eyes, nose, and mouth of a person, and decide on the basis of the geometrical relationships of the features to one another whether it could be a face (two-dimensional geometrical measurement). The use of neuronal networks or similar artificial intelligence technologies for recognizing (locating) a face is also conceivable.

The computer system and the image sensor can be configured so that the image depicted on the image sensor is supplied to an image analysis in definable time intervals (for example, every second) in order to ascertain the probability that a face is present on the image.

However, it is also conceivable that the system is configured in such a way that an image is recorded by the image sensor and supplied to an analysis as soon as a distance sensor registers that something is located in the immediate surroundings in front of the device according to the invention.

After the presence of a person has been recognized, various features of the person are registered. The person, of whom the features are registered, will also be referred to hereafter as the “person to be analyzed” or as the “analyzed person” or as the “first person”.

The devices comprise sensors, using which physical and/or mental features of the first person can be determined.

Physical features of a person are understood as bodily features of the person. Examples of physical features are height, weight, sex, and association with an age group. These features may be “read” directly on the body of the person.

The first, second, and third device are configured in such a way that they register the sex of the person as a physical feature. An image sensor, which is connected in each case to a computer system, is preferably in each case used for the contactless determination of the sex in each device.

The face of a person is preferably registered in order to determine the sex.

The same components are preferably used for the determination of the sex which are also used for the determination of the presence of the person.

After a face has been located in a depiction, characteristic features of the face can be analyzed to decide whether it is a man or a woman. The analysis of a face for determining physical and/or mental features is also referred to here as facial recognition (while the face location only has the task of recognizing the presence of a face).

In one preferred embodiment, an artificial neuronal network or a similar machine learning technology is used to determine the sex from the face recording.

Numerous approaches are described in the literature for how features such as the sex of a person can be determined from a digital depiction of the face (see, for example, Okechuwku A. Uwechue, Abhijit S. Pandya: Human Face Recognition Using Third-Order Synthetic Neural Networks, Springer Science+Budiness Media, LLC., 1997, ISBN 978-1-4613-6832-8; Stan Z. Li, Anil K. Kain (Editors), Handbook of Face Recognition, Second Edition, Springer 2011, ISBN 978-0-85729-931-4; Maria De Marsico et al.: Face Recognition in Adverse Conditions, Advances in Computational Intelligence and Robotics Book Series 2014, ISBN 978-1-4666-5966-7; Thirimachos Bourlai (Editor): Face Recognition Across the Imaging Spectrum, Springer 2016, ISBN 978-3-319-28501-6; http://www.iis.fraunhofer.de/de/ff/bsy/tech/bildanalyse/shore-gesichtsdetektion.html).

The age represents a further bodily feature which is registered by the first, second, and third device. No method is previously known however, using which the exact age of a person can be determined via a contactless sensor. However, the approximate age may be determined on the basis of various features which can be contactlessly registered. In particular the appearance of the skin, above all in the face, gives information about the approximate age. Since an exact age has previously not been determinable by sensors, the association with an age group is the goal in the present case.

The association with an age group (as with the sex of a person) is preferably also determined by means of an image sensor which is connected to a computer system, on which facial recognition software runs. The same hardware is preferably used for determining the association with an age group as for the determination of the sex.

An artificial neuronal network or a comparable machine learning technology is preferably used for determining the association of a person with an age group.

The age groups may be defined arbitrarily in principle in this case, for example, one could define a new age group every 10 years: persons in the age from 0 to 9 years, persons in the age from 10 to 19, persons in the age from 20 to 29, etc.

However, the breadth of variation in the age-specific features which can be registered in a contactless manner for humans in the age from 0 to 9 years is substantially greater than that for humans in the age from 20 to 29 years. An allocation into age groups which takes the breadth of variation into consideration is thus preferable.

An age may also be estimated in years and this age may be specified together with a relative or absolute error.

Further physical features which may be contactlessly determined with the aid of an image sensor are, for example: height, weight, hair color, skin color, hair length/hair fullness, spectacles, posture, gait, inter alia.

To determine the height of a person, it is conceivable, for example, to depict the head of the standing person on an image sensor and to determine the distance of the person from the image sensor using a distance meter (for example, using a laser distance measuring device, which measures the runtime and/or the phasing of a reflected laser pulse). The height of the person then results from the location of the depicted head on the image sensor and the distance of the person from the image sensor in consideration of the optical elements between image sensor and person.

The weight of a person may also be estimated from the height and the width of the person. Height and width may be determined by means of the image sensor.

In addition to the physical features mentioned, mental features are also registered at least by means of the third device. Mental features are to be understood as features which permit inferences about the mental state of a person. In the final analysis, the mental features are also bodily features, i.e., features which can be recognized and registered on the body of a human. In contrast to the solely physical features, however, the mental features are to be attributed either directly to a mental state or they accompany a mental state.

One feature which is a direct expression of the mental state of a person is, for example, the facial expression: a smiling person is in a better mental state than a crying person or an angry person or a fearful person.

In one embodiment of the present invention, the third device has an image sensor having connected computer system and software for the facial recognition which is configured so that it derives the mood of the person from the facial expression (e.g. happy, sad, angry, fearful, surprised, inter alia).

The same hardware can be used to determine the facial expression which is also used to determine the age.

The following moods are preferably differentiated: angry, happy, sad, and surprised.

One feature which is an indirect expression of the mental state of a person is, for example, the body temperature. An elevated body temperature is generally a sign of an illness (with accompanying fever); an illness generally has a negative effect on the mental state; persons with fever “usually do not feel well.”

In one preferred embodiment, the temperature of the skin is preferably determined in the face, preferably on the forehead of the person.

Infrared thermography can be used for the contactless temperature measurement (see, for example, Jones, B. F.: A reappraisal of the use of infrared thermal image analysis in medicine. IEEE Trans. Med. Imaging 1998, 17, 1019-1027).

A further feature which can be an indirect expression of the mental (and physical) state of a person is the heart rate. An elevated heart rate can indicate nervousness or fear or also an organic problem.

Various methods are known, using which the heart rate can be determined contactlessly by means of an image sensor having a connected computer system.

Oxygen-rich blood is pumped into the arteries with every heartbeat. Oxygen-rich blood has a different color than oxygen-poor blood. The pulsing color change can be recorded and analyzed using a video camera. The skin is typically irradiated using red or infrared light for this purpose and the light reflected from the skin is captured by means of a corresponding image sensor. In this case, the face of a person is typically registered, since it is typically not covered by clothing. More details can be taken, for example, from the following publication and the references listed in the publication: http://www.cv-foundation.org/openaccess/content_cvpr_workshops_2013/W13/papers/Gault_A_Fully_Automatic_2013_CVPR_paper.pdf.

Another option is the analysis of head movements, which are caused by the pumping of blood in the head of a person (see, for example, https://people.csail.mit.edu/mrub/vidmag/papers/Balakrishnan_Detecting_Pulse_from_201 3_CVPR_paper.pdf).

The head movement is preferably analyzed by means of a video camera. In addition to the movements which are caused by the pumping of blood in the head (pumping movements), the analyzed person could execute further head movements (referred to here as “natural head movements”), for example, those head movements which are executed when the analyzed person permits his gaze to wander. It is conceivable to ask the person to be analyzed to keep the head still for the analysis. However, as described at the outset, the registration according to the invention of features is to take place substantially without action of the person to be analyzed. A video sequence of the head of the person to be analyzed is therefore preferably preprocessed in order to eliminate the natural head movements. This is preferably performed in that facial features, for example, the eyes, the eyebrows, the nose and/or the mouth are fixed in successive image recordings of the video sequence at fixed points in the image recordings. Thus, for example, if the center points of the pupils travel as a result of a rotation of the head within the video sequence from two points x^{r}₁, y^{r}₁ and x¹₁, y¹₁ to two points x^{r}₂, y^{r}₂ and x¹₂, y¹₂, the video sequence is thus processed in such a way that the center points of the pupils remain at the two points x^{r}₁, y^{r}₁ and x¹₁, y¹₁. The “natural head movement” is thus eliminated and the pumping movement remains in the video sequence, which can then be analyzed with regard to the heart rate.

Inferences about the mental state of a person may also be drawn on the basis of the voice (see, for example, Petri Laukka et al.: In a Nervous Voice: Acoustic Analysis and Perception of Anxiety in Social Phobics' Speech, Journal of Nonverbal Behaviour 32(4): 195-214, December 2008; Owren, M. J., & Bachorowski, J.-A. (2007). Measuring emotion-related vocal acoustics. In J. Coan & J. Allen (Eds.), Handbook of emotion elicitation and assessment (pp. 239-266). New York: Oxford University Press; Scherer, K. R. (2003). Vocal communication of emotion: A review of research paradigms. Speech Communication, 40, 227-256).

In one preferred embodiment, the third device comprises a (directional) microphone having a connected computer system, using which the voice of a person can be recorded and analyzed. A stress level is determined from the voice pattern. Details are disclosed, for example, in U.S. Pat. No. 7,571,101 B2, WO201552729, WO2008041881 or U.S. Pat. No. 7,321,855.

Illnesses may also be concluded on the basis of mental and/or physical features. This applies above all to features in which the registered values deviate from “normal” values. One example is the “elevated temperature” (fever) already mentioned above, which can indicate an illness.

A very high value of the heart rate or an unusual rhythm of the heartbeat can be signs of illnesses.

There are approaches for determining the presence of an illness, for example, Parkinson's disease, from the voice (Sonu R. K. Sharma: Disease Detection Using Analysis of Voice Parameters, TECHNIA—International Journal of Computing Science and Communication Technologies, VOL. 4 NO. 2, January 2012 (ISSN 09743375)).

In one preferred embodiment, at least the first device is embodied so that it has a display screen and sensors in each of two opposite directions for determining the sex and the association with an age group, so that this device can register persons who move toward the device from opposite directions simultaneously. In one particularly preferred embodiment, the first device has two display screens for displaying items of information and two cameras using which the sex and the approximate age can be determined.

In one preferred embodiment, a fourth device exists, which comprises a fifth display screen for displaying items of information. The fourth device is preferably connected to the third device in such a manner that items of information are displayed on the fifth display screen when items of information are also displayed on the third display screen, wherein the items of information are preferably adapted to one another, which means that that they relate to the same theme (for example, the same product).

In addition to the corresponding sensors, the devices have means for reading out the sensors and for analyzing the read-out data. For this purpose, one or more computer systems are used. A computer system is a device for electronic data processing by means of programmable computing rules. The computer system typically has a processing unit, a control unit, a bus unit, a memory, and input and output units according to the von Neumann architecture.

According to the invention, the raw data determined from the sensors are firstly analyzed to determine features for physical and/or mental states of the analyzed person. Items of information which match with the determined features of the person are subsequently displayed on the display screens. Items of information adapted to the features are displayed on the display screens depending on which features were determined.

This has the advantage that items of information are displayed which are adapted to the respective person. Accordingly, selective informing of the person takes place.

If, for example, the sex has been determined by means of a sensor, sex-specific items of information can thus be displayed on the display screen depending on the respective sex. If the person is a woman, items of information can thus be displayed which typically relate to and/or interest women. If the person is a man, items of information can thus be displayed which typically relate to and/or interest men.

If, for example, an association with an age group has been determined by means of one or more sensors in addition to the sex, sex-specific and age-specific items of information can thus be displayed on the display screen in dependence on the respective sex and the respective age group. If the person is a woman in the age from 20 to 30 years, items of information can thus be displayed which typically relate to and/or interest women of this age. If the person is a man in the age from 50 to 60 years, items of information can thus be displayed which typically relate to and/or interest men of this age.

It is also conceivable that in addition to the items of information displayed on a display screen, auditory and/or olfactory items of information are presented. A visual representation can be assisted by tones and/or spoken words. Odors can be emitted. In addition to the assistance and/or supplementation of the visual information, these additional sensory stimulations are also used for attracting the attention of the person to be analyzed, for example, to achieve a better orientation of the person in relation to the sensors.

It is conceivable to select the items of information displayed on a display screen in such a way that they are to trigger a reaction in the person to be analyzed. The specific reaction of the person to be analyzed can then be registered by means of suitable sensors, analyzed, and evaluated.

The devices are preferably arranged in such a way that a person on their way (for example, through a pharmacy) firstly passes the first device, then passes the second device, and subsequently encounters the third device and possibly a fourth device.

In one preferred embodiment, multiple or all of the devices are networked with one another. If one device is networked with another device, the device can thus transmit items of information to the networked device and/or receive items of information from the networked device.

It is conceivable, for example, that the first device determines the presence, the sex, and the age of a person and the second device transmits that possibly in a short time a person having the corresponding age and the corresponding sex could step in front of the second device, so that the second device is “prepared”.

It is also conceivable that two adjacent devices have means for identification of a person, for example, by means of facial recognition. This means that a first person is registered by one device and is recognized again by the other device upon appearing in front of the other device. In such a case, the other device already “knows” which items of information have been displayed to the person by the adjacent device and “can adjust itself thereto”.

It is also conceivable that a device determines the length of the time span during which a person is located in front of the device. In addition to the stopping duration alone, it is preferably registered which items of information have been displayed during this stop. It is conceivable that these items of information are relayed to an adjacent device, so that the adjacent device “knows” which items of information the person has already had displayed, in order “to be able to adjust itself thereto”.

If the stopping time of the person to be analyzed, for example, in front of the first and in front of the second device is comparatively short, this can thus indicate that the displayed theme does not interest this person. Another theme could then be displayed on the third device and possibly a fourth device.

In one preferred embodiment, the amount of information and/or the depth of information which are displayed on a display screen are adapted to the expected waiting time of the person on their path along the devices.

The amount of information and/or depth of information preferably increases along the path of the person from the first device, via the second device, to the third and possibly to a fourth device.

The same theme is preferably addressed on the display screens of the devices. The amount of information and/or depth of information depicted preferably increases from the first device, via the second device, to the third and possibly to a fourth device. The picking up of the same theme from device to device results in recognition. The increasing amount of information and/or depth of information results in deepening of the information.

In one preferred embodiment, the first device is located in the entry region of a business or a government office or a practice or the like. The entry region is understood in this case as both a region before the entry and also a region immediately after the entry and also the entry itself.

The third and possibly a fourth device are preferably located in a region in which an interaction (for example, a customer conversation) typically takes place between the first person to be analyzed and a further person (the “second person”).

The second device is preferably located between the first and the third devices, so that the first person passes the first and then the second device in succession on their path from the entry region to the interaction region, to then encounter the third (and possibly a fourth) device.

In one preferred embodiment, the devices are used in a pharmacy or a comparable business for advertising medications.

A first device in the entry region registers the sex and the age group of the person to be analyzed. A health theme is preferably addressed on the display screen, which typically relates to and/or interests a person of the corresponding age and the corresponding sex. A single depiction is preferably displayed on the display screen, which can be registered by the person in passing. For example, displaying an image having one or more words by which a theme is outlined is conceivable.

If the person to be analyzed moves toward the second device, which is preferably located between entry region and sales counter, the age and the sex are thus again determined. The person is possibly recognized. The theme outlined previously on the first display screen is deepened on the second display screen. It is conceivable that a short video sequence of 1 to 10 seconds displays more items of information on the theme.

If the person to be analyzed moves toward the third device, which is preferably located in the region of the sales counter, the age and the sex are thus again determined. The person is possibly recognized. In addition, the features temperature of the skin, preferably in the face, heart rate, and mood (for example, by means of facial recognition and/or voice analysis) are additionally registered.

The registered features are preferably displayed opposite to the second person (preferably the pharmacist) via the fourth display screen, so that he can use these items of information for a selective conversation.

Features which may be displayed in the form of numbers (body temperature, heart rate, body height, estimated weight) are preferably displayed as numbers on the first display screen.

Features which may be displayed by means of letters (for example, the sex) are preferably displayed by means of letters (for example, “m” for male and “f” for female). However, it is also conceivable to use symbols for the display of the sex.

Symbols can be used for features which may be displayed only poorly or not at all by means of numbers and/or letters.

For example, the mood preferably derived from the facial analysis and/or voice analysis may be displayed with the aid of an emoticon (for example, “ [symbol] )” for good mood and “ [symbol] )” for bad mood).

Colors can be used to make the displayed items of information more easily comprehensible. For example, a red color could be used for the measured temperature if the temperature is above the normal values (36.0° C.-37.2° C.), while the temperature is displayed in a green color tone if it is within the normal value range.

It is also conceivable that multiple features are summarized in one item of displayed information. For example, if it results from the facial recognition and the heart rate measurement that a person is stressed, a character for a stressed person could be displayed on the first display screen.

A fourth device is preferably provided which—from the viewpoint of the person to be analyzed—is located behind the sales counter in the region of the product shelves. The fourth device comprises a fifth display screen, on which preferably the same items of information are displayed as on the third display screen.

The invention will be explained in greater detail hereafter on the basis of a specific example, without wishing to restrict it to the features of the example.

Internal studies have shown that the optimum placement of PoS materials (PoS: point of sale), for example, in a pharmacy, results in more selective informing of the customer with appropriate items of information and thus in an increased impulse purchase rate. The system described here is based on the optimum placements resulting from this study of the PoS materials (four touch points) and expands these touch points with digital technologies. The first customer contact occurs in front of the pharmacy via the digital sidewalk sign, which recognizes sex and age and displays specific items of information on the basis of these data (first device). It is advantageous in this case if this touch point operates in two directions (front camera+monitor, rear camera+monitor), to ensure a maximum number of customer contacts.

The second customer contact occurs in the so-called free choice region of the pharmacy (with the aid of the second device). As soon as the camera of this touch point registers the customer (including age+sex), corresponding specific items of information are displayed on the display screen. In addition, the free choice sign has an LED frame, which assumes the colors of the items of information displayed on the display screen and thus artificially expands the display screen region.

In the over-the-counter region (OTC), an OTC sign is located, which, in addition to the camera for age and sex recognition, additionally measures the body temperature, heart rate, and the stress level of the customer (third device). These items of information are to offer a broader information base about the customer to the pharmacist in the consulting conversation, to be able to deal with the customer in a still more individual and selective manner. The system is not to produce diagnoses, but rather is to be available to assist the pharmacist. While the customer sees individual items of information on the display screen oriented toward him (third display screen), the pharmacist sees the measured vital values including stress level and a treatment instruction (for example: “please ask about . . . ” or “offer a blood pressure measurement” or, or, or) on the display screen on the rear side (fourth display screen).

The behind-the-counter display screen (fourth device/tablet PC including fifth display screen) is wirelessly coupled to the OTC display screen and operates synchronously: it displays more extensive information on the items of information already displayed on the OTC display screen.

All displayed items of information/communication can be moving images, stationary images, and/or stationary images having slight animations.

1. A system comprising:
a first device comprising a first display screen for displaying items of information and one or more sensors for recognizing the presence of a first person and for contactlessly determining the following features of the first person: a sex and an association with an age group;
a second device comprising a second display screen for displaying items of information and one or more sensors for recognizing the presence of the first person and for contactlessly determining the following features of the first person: the sex and the association with an age group;
a third device comprising a third and a fourth display screen for displaying items of information and one or more sensors for contactlessly determining the following features of the first person: the sex the association with an age group, a skin temperature, a heart rate, and a mood,
wherein the first, second, and third devices are configured to display items of information on the first, second, and third display screens opposite to the first person, wherein the items of information are selected on the basis of the registered features of the first person,
and wherein the third device is configured to display items of information about the first person on the fourth display screen opposite to a second person.

2. The system of claim 1, wherein two or more of the first, second, and third devices are networked with one another and are configured to exchange items of information about a stopping duration of the first person in front of a respective device or about the items of information displayed during the stop.

3. The system of claim 1, wherein the first, second, and third devices are arranged in such a way that the first person first passes the first device, then passes the second device, and then encounters the third device on their path from an entry region to a region in which an interaction of the first person with the second person takes place.

4. The system of claim 1, comprising: a fourth device having a fifth display screen, wherein contents displayed on the third display screen and on the fifth display screen are adapted to one another.

5. The system of claim 1, wherein the third device comprises an image sensor and uses the image sensor to determine the sex of the first person, the association of the first person with an age group, and the heart rate of the first person, and wherein the third device comprises a thermal camera and uses the thermal camera to determine the skin temperature of the first person.

6. The system of claim 1, wherein the items of information which are displayed on the first, the second, and the third display screen relate to the same theme.

7. The system of claim 1, wherein the amount of information which is displayed on the display screens of the devices increases from the first via the second to the third device.

8. The system of claim 1, wherein the first device has two display screens and two cameras, wherein the two cameras are each arranged to register and analyze two persons who move toward the first device simultaneously, and wherein the two display screens display specific items of information data determined during the analysis.

9. A method comprising:
recognizing the presence of a first person in front of a first display screen;
first registering the following features of the first person: a sex and an association with an age group;
displaying items of information on the first display screen based on the first registered features of the first person;
recognizing the presence of the first person in front of a second display screen;
second registering the following features of the first person: the sex and the association with an age group;
displaying items of information on the second display screen based on the second registered features of the first person;
recognizing the presence of the first person in front of a third display screen;
third registering the following features of the first person: the sex, the association with an age group, a skin temperature, a heart rate, and a mood;
displaying items of information on the third display screen based on the third registered features of the first person; and
displaying items of information about the first person on a fourth display screen opposite to a second person.

10. The method of claim 9, wherein a fourth device is connected to the third device, and items of information are displayed on a fifth display screen, wherein the items of information on the third and the fifth display screens are adapted to one another.

11. The system of claim 5, wherein the third device comprises a microphone, and wherein the third device is configured to use the microphone to carry out a voice analysis of the first person and to determine a stress level of the first person based on the voice analysis.

12. The system of claim 6, wherein the theme is a health theme.

13. The system of claim 4, wherein the items of information which are displayed on the first, the second, the third, and the fifth display screen relate to a same health theme.
